(19) United States
(12) Patent Application Publication
(10) Pub. No.: US 2010/0268818 A1
(43) Pub. Date: Oct. 21, 2010

(54) SYSTEMS AND METHODS FOR FORENSIC ANALYSIS OF NETWORK BEHAVIOR

(76) Inventors: Alfred R. Richmond, Severna Park, MD (US); Peter W. Rung, Lutz, FL (US); David S. Boubion, Tampa, FL (US); Mary Claire Ryan, Burr Ridge, IL (US)

Correspondence Address: SCHERRER PATENT & TRADEMARK LAW P.C., 17 E. CRYSTAL LAKE AVE, CRYSTAL LAKE, IL, 60014, US

(21) Appl. No.: 12/809,984

(22) PCT Filed: Dec. 22, 2008
(86) PCT No.: PCT/US08/14032

§ 371 Date: Jun. 21, 2010

Related U.S. Application Data
(60) Provisional application No. 61/008,633, filed on Dec. 20, 2007.

(51) Int. Cl. G06F 15/173

(52) U.S. Cl. 709/224

(57) ABSTRACT

Systems and methods monitor and manage computer network traffic and identify a status of normality or consistency of the traffic on a per user, per interne protocol address or MAC address basis. More specifically, the systems and methods determine, with degrees of significance, the abnormality or inconsistency of network traffic from a user, IP address or MAC address based on a comparison of said network traffic to previous network traffic from the same location. Moreover, the systems and methods monitor and manage the network traffic whereby, after an anomaly has occurred, network traffic is tagged as suspicious and thereafter is flagged for forensic study and placed in storage. In addition, the systems and methods report tagged traffic and alert administrators of a breach or violation in the computer network.

The present invention claims priority to U.S. Provisional Patent Application No. 61/008,633, filed Dec. 20, 2007, which is expressly incorporated herein in its entirety.

### BACKGROUND OF THE INVENTION

The present invention relates to the monitoring and management of computer network traffic and identifying a status of normality of the traffic on a per user, per internet protocol address or MAC address basis. More specifically, the present invention determines, with degrees of significance, the abnormality of network traffic from a user, IP address or MAC address based on a comparison of said network traffic to previous network traffic from the same location. Moreover, the present invention relates to the monitoring and management of the network traffic whereby, after an anomaly has occurred, network traffic is tagged as suspicious and thereafter is flagged for forensic study in storage. In addition, the present invention relates to the reporting of tagged traffic, alerting administrators of a breach or violation.

It is generally known that a computer network is comprised of multiple computing devices, such as computers, servers, databases and the like, that are interconnected to each other. The first computer network is believed to have been developed by the Advance Research Projects Agency (ARPA), which designed the “Advanced Research Projects Agency Network” (ARPANET) for the United States Department of Defense in the late 1960's and early 1970's. ARPANET is believed to be the first widely used computer network.

Today, computer networks are prevalent throughout the world, and generally can be classified by their scale. For example, a Local Area Network (LAN) typically involves a small, discrete number of computers that are interconnected to each other within the same geographical location, such as within a home, office, building or small group of buildings. A Wide Area Network (WAN) is a computer network that covers a broad area and can include a network whose communications links cross metropolitan, regional, or national boundaries. The largest and most well-known example of a WAN is the Internet. Another example of a computer network is a Metropolitan Area Network (MAN), which involve a large number of computer networks that span a city. A Personal Area Network (PAN) typically involves a very small number of computing devices that are interconnected together, typically within the same room or within very short distances. Examples may include a wired or wireless interconnection between a computer and a printer, a telephone, a personal digital assistant, a music player, or the like. An additional type of network is a Virtual Private Network (VPN), which is a computer network in which some of the links between nodes are carried by open connections or virtual circuits in some larger network (e.g., the Internet) instead of by physical wires or direct wireless connections.

Once computing devices, such as computers, servers, databases and the like, are networked together, maintaining security over information contained on the computing devices becomes difficult. Typically, with a single computing device, computer inputs and outputs are easily controlled and typically involve small, discrete numbers of access points. For example, a so-called “desktop computer” typically includes a computer keyboard for inputting information or obtaining access to the computer. However, once multiple computing devices (nodes) are added to a network, multiple access points are provided. Moreover, wired computer networks typically offer a higher level of security than wireless networks, since wired computer networks require access via a physical wire or cable, into a node for obtaining access to information contained on the network. Wireless networks, however, provide malicious intruders with higher levels of accessibility, since physical wire or cable access into the network is not necessary, and intruders can, therefore, obtain access to the network over distances without typically being seen, heard or otherwise physically detected.

Intrusion detection, in the context of computer network systems, is the act of detecting actions that attempt to compromise the confidentiality, integrity or availability of a computer network. Intrusion detection can be performed manually or automatically. Manual intrusion detection typically includes an individual examining log files or other evidence for signs of intrusions, including network traffic. A system that performs automated intrusion detection is typically called an Intrusion Detection System (IDS). An IDS can either monitor system calls or logs for signs of intrusion via a signature or marker of a predetermined attack, virus or malware, or monitor the flow of network packets through the computer network. Modern IDSs are usually a combination of these two approaches.

In addition, intrusion detection may include identifying patterns of traffic or application data throughout the network that are presumed to be malicious based on the particular pattern, or may include comparing activities against a “normal” baseline. A “normal” baseline must be developed and maintained in that “normal” has the ability to change for each individual on a network over time, and the degree of “normal” may also change. Finally, without the ability to perform a deep packet inspection on 100% of all network traffic, a definition of “normal” on an individual-by-individual basis cannot be achieved.

Typically, when a probable intrusion is discovered by an IDS, a typical action would be to log the relevant information to a file or database and generate an alert to notify an individual of the suspected intrusion. Typically, this alert involves generating an e-mail or a message that is sent to an individual's computer, cell phone or mobile device. In more stringent occurrences, the network traffic from the individual is halted.

Another form of detection is known as “extrusion detection” and involves the monitoring of outbound data or information. Extrusion detection techniques focus primarily on the analysis of system activity and outbound traffic in order to detect malicious users, malware or network traffic that may pose a threat to the security of neighboring systems.

As noted above, an intrusion or extrusion detection system typically logs the suspected intrusion into a file or database for an individual to review and/or analyze. The logs generated by an IDS typically contain a plurality of textually-based data strings. By analyzing the information contained in the logs, an individual can obtain particular information about the suspected security breach. For example, information in the logs can inform an individual where and when the intrusion attempt or attempts occurred. Other information may include, for example, internal users scanning or attacking outside systems or otherwise having malicious code on their systems, including worms, trojans, viruses and the like. Moreover, security breaches determined by analyzing logs may include invalid users that have obtained access to the network, users accessing what they should not access and/or users accessing when they should not access. And, logs may simply inform an individual of multiple failed login attempts.

Oftentimes, however, typical intrusion detection systems do not provide information that is easy for an individual to understand. For example, logs are typically reviewed by network technicians that are specifically trained to review and/or analyze the logs. Moreover, reviewing logs for patterns of malicious attacks on a network typically takes a large amount of time. If a large number of attacks occur on a network system, it may be difficult for an individual to review and/or analyze the logs in an efficient manner to prevent the occurrence of the intrusion.

Reviewing logs is also a post-event process. At the point logs are reviewed, the damage to a computer network may have already occurred. Reviewing signatures in logs is also a post-event process with the same issues in that the damage to a computer network may have already occurred.

Through the detection of “abnormal” network traffic on an individual address or login basis, and with the ability to inspect 100% of all network packets entering or leaving a network, a system can identify an attack at 0^{th} packet, referred to as a zero day attack.

It is also important to determine where an attack occurs on a network so that future attacks may be prevented. Not only is it difficult for an individual to review and/or analyze the large amount of data contained within the logs, it is difficult to determine where a malicious attack occurs on a network, especially on a very complicated network involving large numbers of computing devices. Moreover, if a large number of attacks are occurring on a network, it is difficult to track and determine where these attacks are occurring. As in the case of detecting the attack, the need for preventing it based on deep packet inspection of 100% of all packets is required, for either signature-based attacks or anomaly attacks.

A need, therefore, exists for a system and a method for efficiently determining, on a per user and/or per address-based perspective, a “normal” or “consistent” status of network traffic entering or leaving a node on a computer network. A need further exists for a system and a method for analyzing network traffic and comparing the network traffic against the “normal” or “consistent” network traffic for determining whether the network traffic matches “normal” or “consistent” network traffic. In addition, a need exists for a system and a method for tagging network traffic as “abnormal” or “inconsistent” if the network traffic fails to sufficiently match network traffic designated as “normal” or “consistent”.

Further, a need is required for a system and a method for taking action once an indication of abnormality or inconsistency of network traffic is designated. Moreover, a need exists for a system and a method for analyzing network traffic designated as “abnormal” or “inconsistent” and determining whether the network traffic is truly “abnormal” or “inconsistent” or whether the designation is an indication of a “false positive” or otherwise is indicative of a mislabeled or incorrectly designated as “abnormal” or “inconsistent”.

### SUMMARY OF THE INVENTION

The present invention relates to the monitoring and management of computer network traffic and identifying a status of normality of the traffic on a per user, per internet protocol address or MAC address basis. More specifically, the present invention determines, with degrees of significance, the abnormality of network traffic from a user, IP address or MAC address based on a comparison of said network traffic to previous network traffic from the same location. Moreover, the present invention relates to the monitoring and management of the network traffic whereby, after an anomaly has occurred, network traffic is tagged as suspicious and thereafter is flagged for forensic study in storage. In addition, the present invention relates to the reporting of tagged traffic, alerting administrators of a breach or violation.

Specifically, the present invention relates to systems and methods of inspection of any network packet or packets for anomalies, including but not limited to viruses, malware, rootkit, keylogger, and other types of malicious, non-normal packets. Upon completion of packet inspection, a determining factor of consistency or inconsistency with the network and the behavior of the user or address on the network is created. Pending this analysis and the analysis above, a critical decision consisting of rules-based logic is taken, to either allow or disallow the packet to traverse the network. If required by the rule, an alert is transmitted notifying administrator or higher of a threat.

Upon completion of the inspection, the determination where the packet and/or packets originated and by whom is logged and maintained.

In advance of any and all action, an administrator determines the user, which could be the particular role of the individual, and determines particular rules prior to any transmission activity. Therefore, consistency or inconsistency can be determined by the user, by the role of the individual, and/or other predetermined rules. Consistency would be the determination of rules regarding logging in and permitting the packets to be sent out. Inconsistency would measure the degree of non-compliance to the user, the role of the individual and the rules. A forensic activity would be conducted in both cases of consistency and inconsistency to determine the actions that would be taken whether blocking or sending out the packets. The system and method tracks the activity based on behaviors. The ability to conduct forensic activity may be up to but not limited to 40 gigabit per second of network traffic.

To this end, in an embodiment of the present invention, a method for determining consistency is provided. The method comprises the steps of: calculating a consistency quotient; analyzing the consistency quotient against a previously stored consistency quotient value; comparing both quotients for consistency; merging the quotients; and storing the newly merged consistency quotient.

In an embodiment of the present invention, a method of determining inconsistency is provided. The method comprises the steps of: calculating a inconsistency quotient; analyzing the inconsistency quotient against a previously stored inconsistency quotient value; comparing both quotients for inconsistency; merging the quotients; and storing the newly merged inconsistency quotient.

In an embodiment of the present invention, a method of determining consistency in a role is provided. The method comprises the steps of: calculating a consistency quotient in a role; analyzing the consistency quotient against a previously stored consistency quotient value in a role; comparing both quotients for consistency in a role; merging the quotients in a role; and storing the newly merged consistency quotient in a role.

In an embodiment of the present invention, a method of determining inconsistency in a role is provided. The method comprises the steps of: calculating a inconsistency quotient in a role; analyzing the inconsistency quotient against a previously stored inconsistency quotient value in a role; comparing both quotients for inconsistency in a role; merging the quotients in a role; and storing the newly merged inconsistency quotient in a role.

In an embodiment of the present invention, a method of determining consistency for a user is provided. The method comprises the steps of: calculating a consistency quotient for a user; analyzing the consistency quotient against a previously stored consistency quotient value for a user; comparing both quotients for consistency for a user; merging the quotients for a user; and storing the newly merged consistency quotient for a user.

In an embodiment of the present invention, a method of determining inconsistency for a user is provided. The method comprises the steps of: calculating a inconsistency quotient for a user; analyzing the inconsistency quotient against a previously stored inconsistency quotient for a user; comparing both quotients for inconsistency for a user; merging the quotients for a user; and storing the newly merged inconsistency quotient for a user.

In an embodiment of the present invention, a method for determining a course of action is provided. Upon the completion of consistency and inconsistency analysis, a method comprised the steps of: measuring a degree of consistency to determine whether action should be taken; measuring a degree of inconsistency to determine whether action should be taken; a retrieving a rule if action should be taken; and acting upon said rule in determining if action should be taken.

In an alternate embodiment of the present invention, a method for analyzing a data stream in a computer network is provided. The method comprises the steps of: providing a computer network having a data stream; calculating a current consistency quotient by analyzing the data stream; comparing the current consistency quotient against a previously stored consistency quotient to determine a consistency value between the currency consistency quotient and the previously stored consistency quotient; combining the current consistency quotient and the previously stored consistency quotient to create a new consistency quotient.

In an embodiment of the present invention, the method comprises the step of providing a node associated with the computer network wherein the data stream flows from the node.

In an embodiment of the present invention, the method comprises the step of providing a user and a node associated with the computer network wherein the user utilizes the network through the node wherein the data stream flows from the node and is associated with the user.

In an embodiment of the present invention, the method further comprises the steps of: providing a user and a node associated with the computer network; and defining a role based on the user utilizing the computer network through the node wherein the data stream is associated with the defined role.

In an embodiment of the present invention, the method further comprises the step of storing the new consistency quotient.

In an embodiment of the present invention, the method further comprises the steps of: analyzing the consistency value between the current consistency quotient and the previously stored consistency quotient; and tagging the data stream if the consistency value between the current consistency quotient and the previously stored consistency quotient is above a predefined level.

In an embodiment of the present invention, the method further comprises the steps of: analyzing the consistency value between the current consistency quotient and the previously stored consistency quotient; providing a rule defining an action to be taken if the consistency value between the current consistency quotient and the previously stored consistency quotient is above a predefined level; and acting on said rule when said consistency value is above a predefined level.

In an embodiment of the present invention, the method further comprises the steps of: analyzing the consistency value between the current consistency quotient and the previously stored consistency quotient; providing a rule defining an action to be taken if the consistency value between the current consistency quotient and the previously stored consistency quotient is above a predefined level; and acting on said rule when said consistency value is above a predefined level wherein the rule includes removing the data stream from the computer network.

In an embodiment of the present invention, the method further comprises the steps of: analyzing the consistency value between the current consistency quotient and the previously stored consistency quotient; tagging the data stream if the consistency value between the current consistency quotient and the previously stored consistency quotient is above a predefined level; and storing the tagged data stream.

In an alternate embodiment of the present invention, a method for detecting a polymorphic worm in a computer network is provided. The method comprises the steps of: providing a computer network having a first node and a second node wherein a first data stream is associated with the first node and a second data stream is associated with the second node; calculating a first consistency quotient by analyzing the first data stream associated with the first node; calculating a second consistency quotient by analyzing the second data stream associated with the second node; and combining the first consistency quotient and the second consistency quotient to form a third consistency quotient.

In an embodiment of the present invention, the method further comprises the step of: comparing the first consistency quotient to the second consistency quotient to determine a consistency value.

In an embodiment of the present invention, the method further comprises the steps of: comparing the first consistency quotient to the second consistency quotient to determine a consistency value; and tagging the first data stream and the second data stream if the consistency value is above a predefined level.

In an embodiment of the present invention, the method further comprises the steps of: comparing the first consistency quotient to the second consistency quotient to determine a consistency value; tagging the first data stream and the second data stream if the consistency value is above a predefined level; and storing the tagged first data stream and the tagged second data stream.

In an embodiment of the present invention, the method further comprising the step of storing the third consistency quotient.

In an alternate embodiment of the present invention, a system for determining a consistency in a data stream in a computer network is provided. The system comprises: a computer network having a data stream; a current consistency quotient calculated by analyzing the data stream; a consistency value calculated by comparing the current consistency quotient against a previously stored consistency quotient; and a new consistency quotient calculated by combining the current consistency quotient and the previously stored consistency quotient.

In an embodiment of the present invention, the system further comprises: a node associated with the computer network wherein the data stream comes from the node.

In an embodiment of the present invention, the system further comprises a user and a node associated with the computer network wherein the user utilizes the network through the node wherein the data stream comes from the node and is associated with the user.

In an embodiment of the present invention, the system further comprises: a user and a node associated with the computer network; and a role based on the user utilizing the computer network through the node wherein the data stream is associated with the role.

In an embodiment of the present invention, the system further comprising a database for storing the new consistency quotient.

It is, therefore, an advantage of the present invention to provide a system and a method for efficiently determining, on a per user and/or per address-based perspective, a “normal” or “consistent” status of network traffic entering or leaving a node on a computer network.

A further advantage of the present invention is to provide a system and a method for analyzing network traffic and comparing the network traffic against the “normal” or “consistent” network traffic for determining whether the network traffic matches “normal” or “consistent” network traffic.

A still further advantage of the present invention is to provide a system and a method for tagging network traffic as “abnormal” or “inconsistent” if the network traffic fails to sufficiently match network traffic designated as “normal” or “consistent”.

Further, an advantage of the present invention is to provide a system and a method for taking action once an indication of abnormality or inconsistency of network traffic is designated.

Moreover, an advantage of the present invention is to provide a system and a method for analyzing network traffic designated as “abnormal” or “inconsistent” and determining whether the network traffic is truly “abnormal” or “inconsistent” or whether the designation is an indication of a “false positive” or otherwise is indicative of a mislabeled designation or otherwise incorrectly designated as “abnormal” or “inconsistent”.

A further advantage of the present invention is to provide a system and a method for determining consistency and inconsistency of network activity from a user, a user in a role, a user at a specific network address, or the network address itself, followed by rules-based action on the network packet in question.

Additionally, an advantage of the present invention is to provide a system and a method for providing a visual representation of the information so that the information may be quickly and efficiently analyzed by an individual.

Additional features and advantages of the present invention are described in, and will be apparent from, the detailed description of the presently preferred embodiments and from the drawings.

### BRIEF DESCRIPTION OF THE DRAWINGS

FIG. 1 illustrates a schematic of an appliance system for analyzing live data at a network node to determine a consistency quotient in an embodiment of the present invention.

FIG. 2 illustrates a schematic of an appliance system for analyzing live data from a user ID to determine a consistency quotient in an embodiment of the present invention.

FIG. 3 illustrates a schematic of an appliance system for analyzing live data from a role designated from nodes and/or users to determine a consistency quotient in an embodiment of the present invention.

FIG. 4 illustrates a schematic of an appliance system for analyzing live data at a network node to determine an inconsistency quotient in an embodiment of the present invention.

FIG. 5 illustrates a schematic of an appliance system for analyzing live data from a user ID to determine an inconsistency quotient in an embodiment of the present invention.

FIG. 6 illustrates a schematic of an appliance system for analyzing live data from a role designated from nodes and/or users to determine an inconsistency quotient in an embodiment of the present invention.

FIG. 7 illustrates a schematic of an appliance system for analyzing live data from a plurality of network nodes to determine consistency quotient from the plurality of network nodes in an embodiment of the present invention.

FIG. 8 illustrates a schematic representation of an appliance system for analyzing a live data stream for determining the characteristic of a network packet thereby providing details on the “normality” of the packet.

### DETAILED DESCRIPTION OF THE PRESENTLY PREFERRED EMBODIMENTS

The present invention relates to the monitoring and management of computer network traffic and identifying a status of normality or “consistency” of the traffic on a per user, per internet protocol address or MAC address basis. More specifically, the present invention determines, with degrees of significance, the abnormality or “inconsistency” of network traffic from a user, IP address or MAC address based on a comparison of said network traffic to previous network traffic from the same location. Moreover, the present invention relates to the monitoring and management of the network traffic whereby, after an anomaly has occurred, network traffic is tagged as suspicious and thereafter is flagged for forensic study and/or placed in storage. In addition, the present invention relates to the reporting of tagged traffic, alerting administrators of a breach or violation.

The term “node” or “nodes” refers to a device or devices attached to a computer network or other telecommunications network. The term “role” or “roles” refers to a set or sets of connected behaviors indicative of a position within a group. The term “user” or “users” refers to an individual or individuals who use a computer system or computer network.

The present invention comprises an appliance that is placed within a computer network to analyze data streams flowing through the computer network. Specifically, the appliance may be a plug-in to an existing system or node having access to a computer network, or may operate as a stand-alone node having access to the computer network for analyzing the data stream. In general, the data stream is analyzed to categorize nodes, roles, users and/or a a combination or hybrid thereof. Moreover, the appliance analyzes behavior of the nodes, roles, users and/or combination or hybrid thereof. The appliance uses a plurality of algorithms to calculate a behavior quotient for that node, role, user and/or combination or hybrid thereof. The quotient, specifically, represents the behavior characteristic of an individual packet or a series of packets associated with a node, role, user and/or combination or hybrid thereof. After the behavior quotient is calculated for the node, role, user and/or combination or hybrid thereof thereby establishing a historical or baseline behavior quotient for the behavior, a comparison is made between the historical behavior quotient and a current or updated

The present invention utilizes the analysis of workflow habits and patterns within the data streams of a computer network. Specifically, nodes, roles, users and/or combinations or hybrids thereof typically have a set number of tasks with which they perform or are in charge of, which then entail performing a finite number of actions. This predictive nature allows for patterns in behavior to be discerned, and more importantly, the ability to discern malicious packets within a data stream is enhanced.

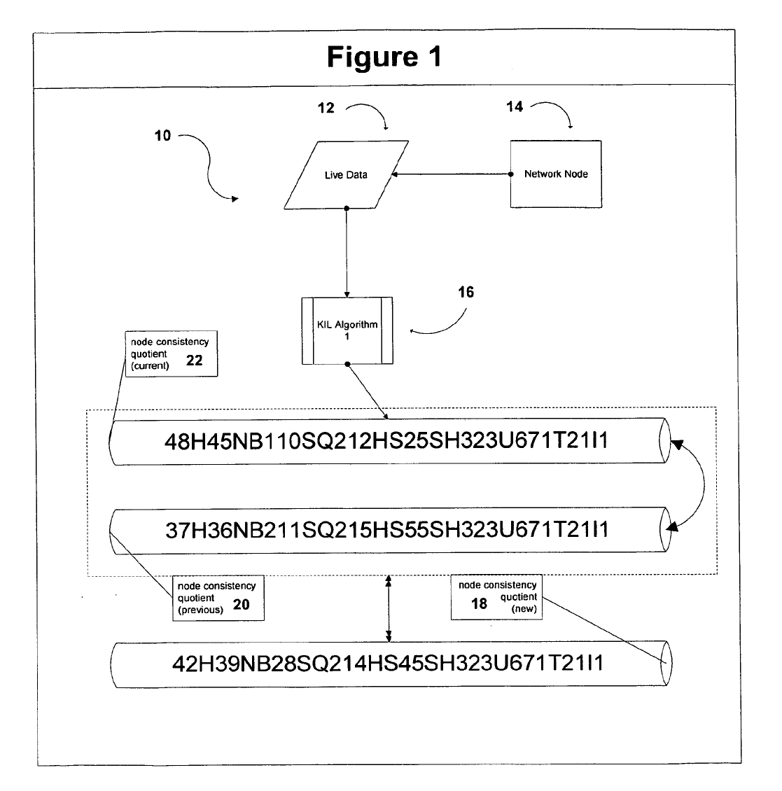

Referring now to the drawings, wherein like numerals refer to like parts, FIG. 1 illustrates a schematic representation of an appliance system 10 that interacts with a live data stream 12 from a specified network node 14. An algorithm 16 calculates a “new consistency quotient” 18, represented by the numerical string shown in FIG. 1. The numerical string is a floating-point integer which is a representation of the behavior of the network node 14 identified by a percentage usage number, followed by a protocol type, followed by a percentage number deviation of the first usage number. The new consistency quotient 18 is calculated using a previously stored consistency quotient 20 which is compared against a current consistency quotient 22.

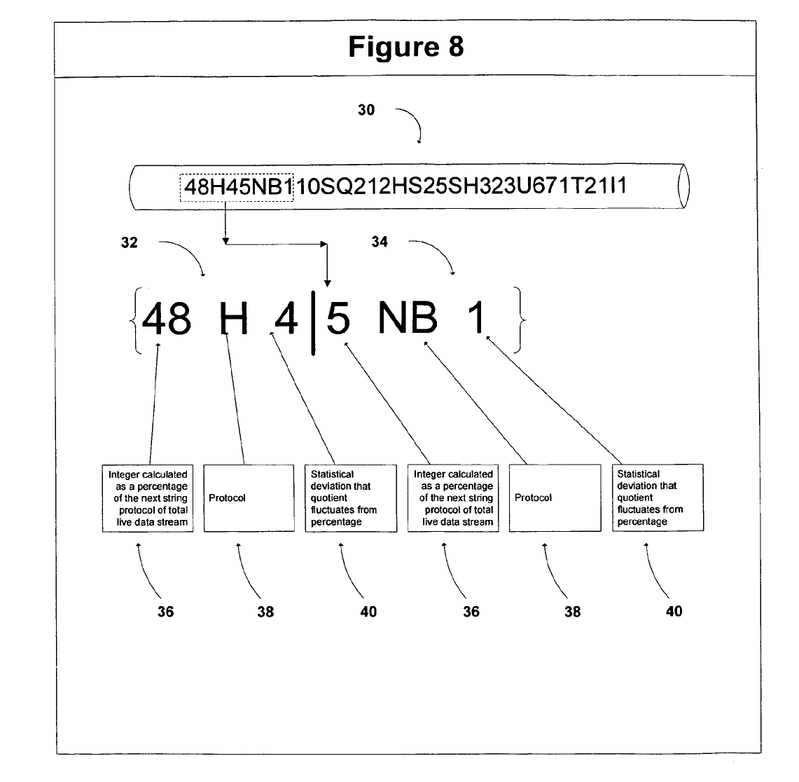

FIG. 8 illustrates a unique consistency quotient represented by a numerical string 30. The numerical string 30 represent an entity's distilled behavior. Specifically, an entity may include a user, a node, a role and/or a combination or hybrid thereof. As illustrated in FIG. 8, the quotient is divided into multiple three-item sets, two of which are illustrated in FIG. 8 (32, 34). The first integer 36 in each of the multiple three-item sets 32, 34 represents a percentage of total traffic. The second integer 38 represents a particular network protocol for the data packet. The third packet 40 represents a statistical deviation from the first integer in the set. Preferably, each entity will have at least two sets, but more are likely depending on the operating system utilized, applicants serving and accessing, the network configuration, and other like properties of the entity.

The present invention starts by separating (i.e. analyzing) particular data flows depending on the algorithm used, whether for a node, a role, a user or for a combination thereof. For example, from the beginning of a computer network, a node may just have come online which has never been seen or otherwise detected within a computer network. The node begins transmitting traffic as soon as it is connected to the network. Statistical analysis is utilized to determine the percentages of the total traffic seen for this node, as shown in FIG. 8.

The present invention classifies all data from the node and combines it together into the quotient for each data packet. The quotient for each data packet will be constantly evaluated and re-calculated to determine the statistical deviation as compared to prior calculations. As the calculations progress over time, quotients from similar nodes that are classified in the same role can be used to cross-check and enhance the validity of the statistical deviation. The object is to detect a malicious behavior at the smallest deviation integer possible. Specifically, the present invention may analyze the deviation integer and determine whether the deviation is large enough to warrant a warning or otherwise tag the data packet for further review for possible malicious intrusion.

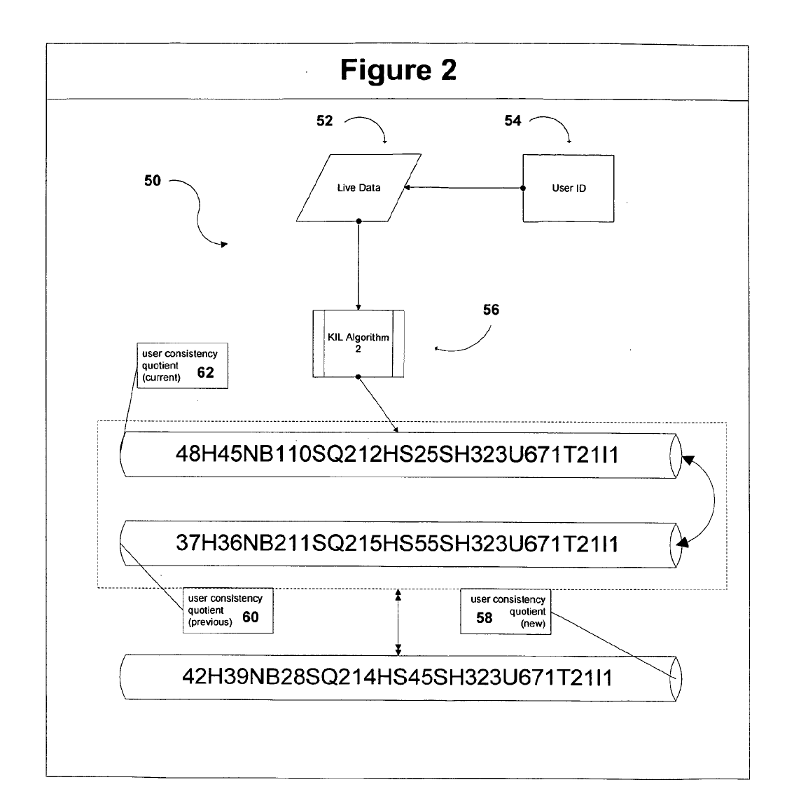

As demonstrated in FIG. 2, a schematic representation of an appliance system 50 is shown. The appliance system 50 interacts with a live data stream 52 that is known to come from a specified user ID 54, thereby indicating a data stream from a particular user. An algorithm 56 calculates a consistency quotient associated with a user ID 54, instead of a network node, as illustrated in FIG. 1. The algorithm 56 follows individual user behavior by calculating a new consistency quotient 58, represented by the numerical string shown in FIG. 2. The new consistency quotient 58 is represented by a floating-point integer which is a representation of its behavior identified by a percentage usage number, followed by a protocol type, followed by a percentage number deviation of the first percentage usage number. The new consistency quotient 58 is calculated using a previously stored consistency quotient 60 compared against the current consistency quotient 62.

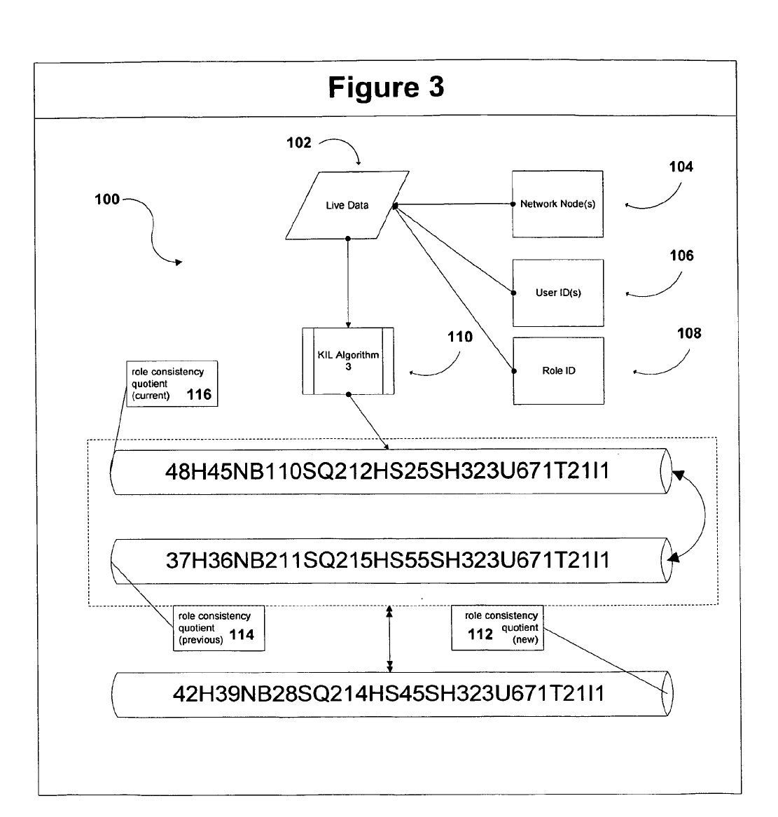

As demonstrated in FIG. 3, a schematic representation of an appliance system 100 is shown. The appliance system 100 interacts with a live data stream 102 combining various quotients from network nodes 104 and users 106 that are grouped or categorized into defined roles 108. An algorithm 110 calculates a new consistency quotient 112 for the combination of network nodes 104 and users 106 that are grouped or categorized into defined roles 108, represented by the numerical string shown in FIG. 3. The new consistency quotient 112 is represented by a floating-point integer which is a representation of its behavior identified by a percentage usage number, followed by a protocol type, followed by a percentage number deviation of the first percentage usage number. The new consistency quotient 112 is calculated using a previously stored consistency quotient 114 compared against the current consistency quotient 116.

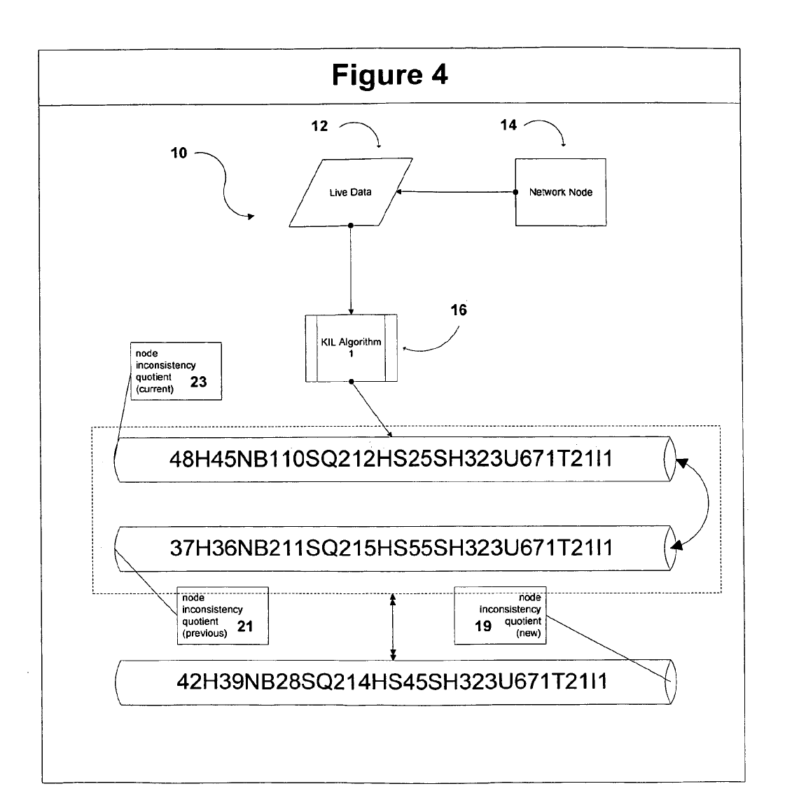

FIG. 4 illustrates a schematic representation of the appliance system 10 (as illustrated in FIG. 1) that interacts with the live data stream 12 from the specified network node 14. The algorithm 16 calculates a “new inconsistency quotient” 19, represented by the numerical string shown in FIG. 1. The numerical string is a floating-point integer which is a representation of the behavior of the network node 14 identified by a percentage usage number, followed by a protocol type, followed by a percentage number deviation of the first usage number. The new inconsistency quotient 19 is calculated using a previously stored inconsistency quotient 21 which is compared against a current consistency quotient 23.

As demonstrated in FIG. 4, a schematic representation of the appliance system 50 is shown. The appliance system 50 interacts with the live data stream 52 that is known to come from the specified user ID 54, thereby indicating the data stream from the particular user. An algorithm 56 calculates an inconsistency quotient associated with a user ID 54, instead of a network node, as illustrated in FIG. 3. The algorithm 56 follows individual user behavior by calculating a new inconsistency quotient 59, represented by the numerical string shown in FIG. 4. The new inconsistency quotient 59 is represented by a floating-point integer which is a representation of its behavior identified by a percentage usage number, followed by a protocol type, followed by a percentage number deviation of the first percentage usage number. The new consistency quotient 59 is calculated using a previously stored consistency quotient 61 compared against the current consistency quotient 63.

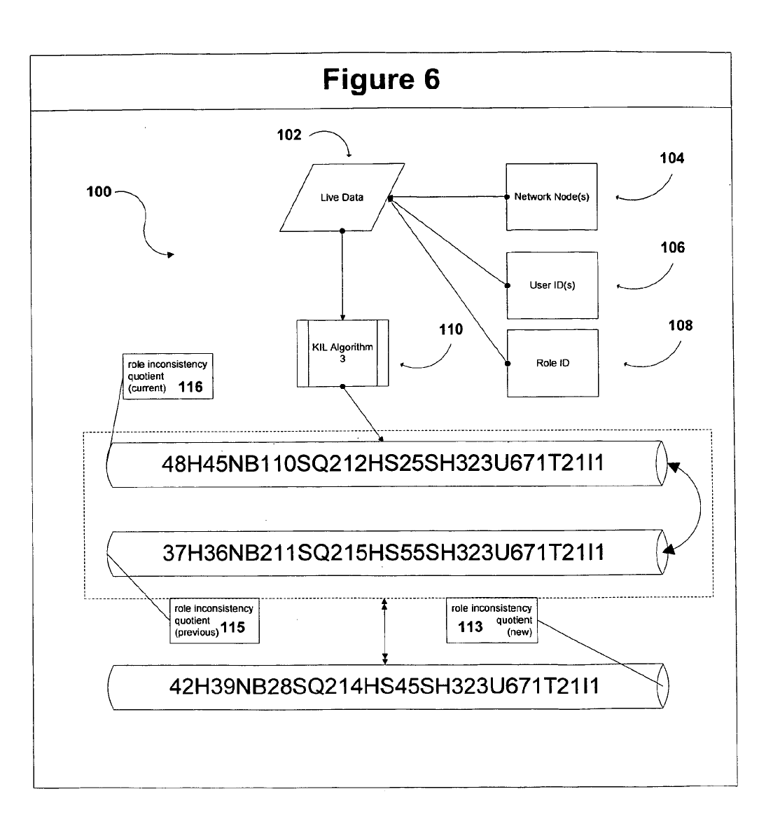

As demonstrated in FIG. 6, a schematic representation of an appliance system 100 is shown. The appliance system 100 interacts with the live data stream 102 combining various quotients from network nodes 104 and users 106 that are grouped or categorized into defined roles 108. The algorithm 110 calculates a new inconsistency quotient 113 for the combination of network nodes 104 and users 106 that are grouped or categorized into the defined roles 108, represented by the numerical string shown in FIG. 6. The new inconsistency quotient 113 is represented by a floating-point integer which is a representation of its behavior identified by a percentage usage number, followed by a protocol type, followed by a percentage number deviation of the first percentage usage number. The new inconsistency quotient 113 is calculated using a previously stored inconsistency quotient 115 compared against the current inconsistency quotient 117.

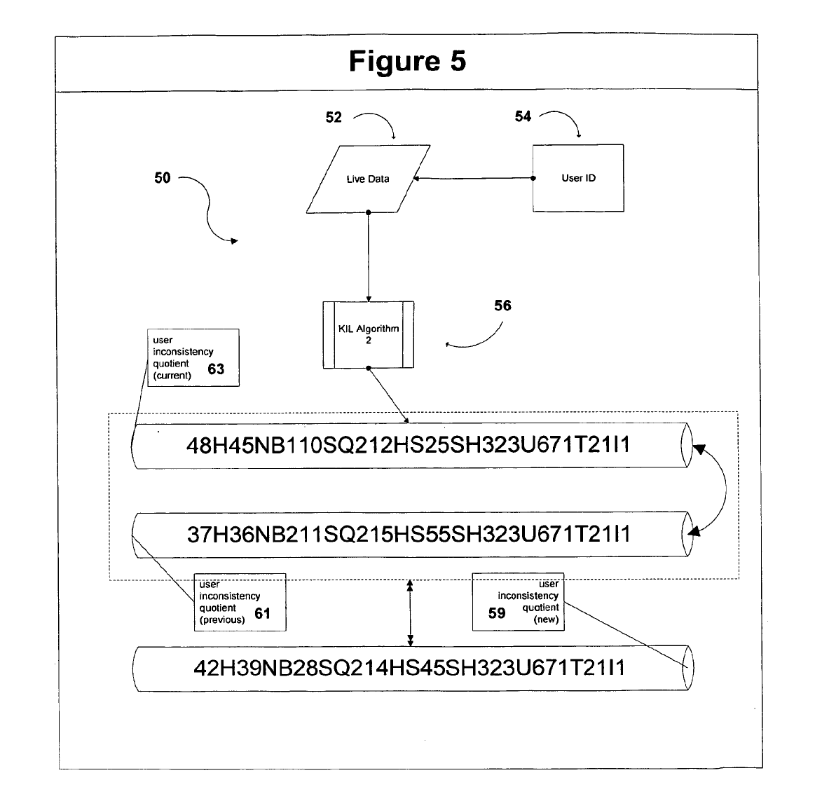

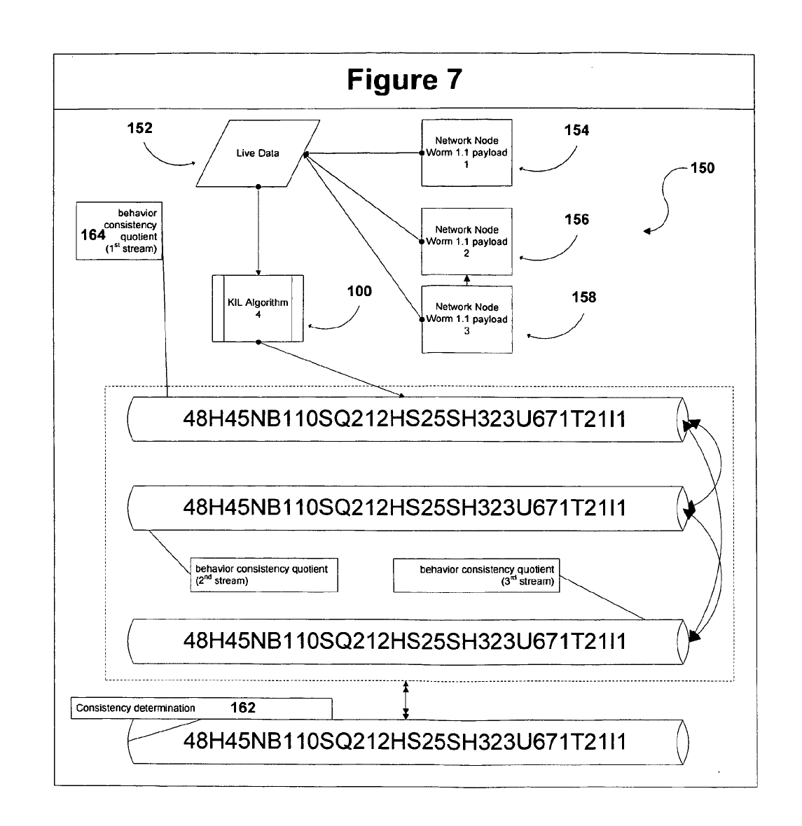

As illustrated in FIG. 7, an appliance system 150 is shown. The appliance system 150, similar to the appliance systems described above with respect to FIGS. 1-6, process data streams from different sources but analyzing similar behavior patterns. This provides the appliance system 150 with the ability to detect a polymorphic worm that has the ability to change its payload and signatures from or at each node or user, thus preventing traditional detection or prevention. Specifically, by calculating a behavior consistency quotient on multiple data streams, the appliance system 150 is able to compare and then make a consistency determination that points to a polymorphic worm, having the different payloads, signatures and/or entry points.

Instead of calculating a new consistency quotient by comparing a current consistency quotient with a previous consistency quotient (as illustrated in FIGS. 1-3), the appliance system 150 calculates a new consistency quotient by analyzing a live data stream 152 from multiple network nodes 154, 156 and 158, each having worm 1.1, but with differing payloads. An algorithm 160 calculates a consistency quotient 162 for the combination of network nodes 154, 156 and 158, represented by the numerical string shown in FIG. 3. The consistency quotient 112 is represented by a floating-point integer which is a representation of its behavior identified by a percentage usage number, followed by a protocol type, followed by a percentage number deviation of the first percentage usage number. The consistency quotient 162 is calculated using a first behavior consistency quotient 164 from the first network node 154, a second behavior consistency quotient 166 from the second network node 156, and a third behavior consistency quotient from the third network node 158.

Once a consistency quotient is determined for a data packet, as described above with reference to FIGS. 1-8, a rule may be defined whereby the rule provides an action to be taken. For example, if the consistency or inconsistency quotient breaches a predefined threshold, the data packet may be tagged for further review to determine whether the data packet contains malicious code or is otherwise compromised. Alternatively, the rule may specify that the data packet be removed from the data stream so that the data packet cannot cause damage to the computer network or one or more nodes within the data packet. Other rules may be defined for handling the data packet having the consistency quotient that breaches a particular threshold, and the invention should not be limited as herein described.

It should be understood that various changes and modifications to the presently preferred embodiments described herein will be apparent to those skilled in the art. Such changes and modifications may be made without departing from the spirit and scope of the present invention and without diminishing its attendant advantages.

I claim:

1. A method for analyzing a data stream in a computer network, the method comprising the steps of:
providing a computer network having a data stream;
calculating a current consistency quotient by analyzing the data stream;
comparing the current consistency quotient against a previously stored consistency quotient to determine a consistency value between the currency consistency quotient and the previously stored consistency quotient;
combining the current consistency quotient and the previously stored consistency quotient to create a new consistency quotient.

2. The method of claim 1 further comprising the step of:
providing a node associated with the computer network wherein the data stream flows from the node.

4. The method of claim 1 further comprising the step of:
providing a user and a node associated with the computer network wherein the user utilizes the network through the node wherein the data stream flows from the node and is associated with the user.

5. The method of claim 1 further comprising the steps of:
providing a user and a node associated with the computer network; and
defining a role based on the user utilizing the computer network through the node wherein the data stream is associated with the defined role.

6. The method of claim 1 further comprising the step of:
storing the new consistency quotient.

7. The method of claim 1 further comprising the steps of:
analyzing the consistency value between the current consistency quotient and the previously stored consistency quotient; and
tagging the data stream if the consistency value between the current consistency quotient and the previously stored consistency quotient is above a predefined level.

8. The method of claim 1 further comprising the steps of:
analyzing the consistency value between the current consistency quotient and the previously stored consistency quotient; and
providing a rule defining an action to be taken if the consistency value between the current consistency quotient and the previously stored consistency quotient is above a predefined level; and
acting on said rule when said consistency value is above a predefined level.

9. The method of claim 1 further comprising the steps of:
analyzing the consistency value between the current consistency quotient and the previously stored consistency quotient;
providing a rule defining an action to be taken if the consistency value between the current consistency quotient and the previously stored consistency quotient is above a predefined level; and
acting on said rule when said consistency value is above a predefined level wherein the rule includes removing the data stream from the computer network.

10. The method of claim 1 further comprising the steps of:
analyzing the consistency value between the current consistency quotient and the previously stored consistency quotient;
tagging the data stream if the consistency value between the current consistency quotient and the previously stored consistency quotient is above a predefined level; and
storing the tagged data stream.

11. A method for detecting a polymorphic worm in a computer network, the method comprising the steps of:
providing a computer network having a first node and a second node wherein a first data stream is associated with the first node and a second data stream is associated with the second node;
calculating a first consistency quotient by analyzing the first data stream associated with the first node;
calculating a second consistency quotient by analyzing the second data stream associated with the second node; and
combining the first consistency quotient and the second consistency quotient to form a third consistency quotient.

12. The method of claim 11 further comprising the step of:
comparing the first consistency quotient to the second consistency quotient to determine a consistency value.

13. The method of claim 11 further comprising the steps of:
comparing the first consistency quotient to the second consistency quotient to determine a consistency value; and
tagging the first data stream and the second data stream if the consistency value is above a predefined level.

14. The method of claim 11 further comprising the steps of:
comparing the first consistency quotient to the second consistency quotient to determine a consistency value;
tagging the first data stream and the second data stream if the consistency value is above a predefined level; and
storing the tagged first data stream and the tagged second data stream.

15. The method of claim 11 further comprising the step of:
storing the third consistency quotient.

16. A system for determining a consistency in a data stream in a computer network comprising:
a computer network having a data stream;
a current consistency quotient calculated by analyzing the data stream;
a consistency value calculated by comparing the current consistency quotient against a previously stored consistency quotient; and
a new consistency quotient calculated by combining the current consistency quotient and the previously stored consistency quotient.

17. The system of claim 16 further comprising:
a node associated with the computer network wherein the data stream comes from the node.

18. The system of claim 16 further comprising:
a user and a node associated with the computer network wherein the user utilizes the network through the node wherein the data stream comes from the node and is associated with the user.

19. The system of claim 16 further comprising:
a user and a node associated with the computer network; and
a role based on the user utilizing the computer network through the node wherein the data stream is associated with the role.

20. The system of claim 16 further comprising:
a database for storing the new consistency quotient.
